(19) United States
(12) Patent Application Publication
(10) Pub. No.: US 2025/0168633 A1
(43) Pub. Date: May 22, 2025

(54) OPEN ROAMING SECURITY ENHANCEMENTS

(71) Applicant: Cisco Technology, Inc., San Jose, CA (US)

(72) Inventors: Robert E. BARTON, Richmond (CA); Jerome HENRY, Pittsboro, NC (US); Bhavik P. SHAH, Bangalore (IN); Mark GRAYSON, Maidenhead (GB)

(21) Appl. No.: 18/517,309

(22) Filed: Nov. 22, 2023

(51) Int. Cl. H04W 12/06; H04W 12/40

(52) U.S. Cl. CPC H04W 12/06; H04W 12/40

(57) ABSTRACT

Techniques for enhancing the security of network access within an open roaming framework are provided. A first network device receives a request to authenticate connection of a user device to a network. The first network device retrieves security data associated with the network. Based on analyzing the security data associated with the network, the first network device determines that one or more security criteria are satisfied. The first network device transmits a response to the user device, where the response instructs the user device to establish a connection with the network and does not disclose the security data.

### TECHNICAL FIELD

Embodiments presented in this disclosure generally relate to wireless communication. More specifically, embodiments disclosed herein relate to security-enhanced open roaming system for network access.

### BACKGROUND

Open Roaming (OR) is gaining in popularity as a mechanism to streamline access to hotspot networks. Specifically, the OR uses a federation-based system that recognizes a user's credentials across all participating networks. This approach allows users to roam between different networks without the need for repeated authentications or sign-ins.

As users attempt to onboard their devices onto these networks, inherent risks arise. Not all networks maintain the same security standards, and the reputation of some networks may be questionable. The current OR system, however, does not have the capability of informing user devices about a network's security posture or reputation of a network before they establish a connection.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example of the Open Roaming (OR) framework that supports security enhancements, according to some embodiments of the present disclosure.

FIG. 2 is a diagram depicting a sequence for retrieving and evaluating security data before connecting a user device to a federation-based network, according to some embodiments of the present disclosure.

FIG. 3 is a diagram depicting a sequence for retrieving and evaluating a signed security report before connecting a user device to a federation-based network, according to some embodiments of the present disclosure.

FIG. 4 depicts an example method for assessing a network's security data by an Identity Provider (IdP), according to some embodiments of the present disclosure.

FIG. 5 depicts an example method for querying and transmitting a network's signed security report by an access network provider (ANP), according to some embodiments of the present disclosure.

FIG. 6 depicts an example method for evaluating a network's signed security report by a user device, according to some embodiments of the present disclosure.

FIG. 7 is a flow diagram depicting an example method for an enhanced security check without disclosing the detailed security data of a network to a user device, according to some embodiments of the present disclosure.

FIG. 8 is a flow diagram depicting an example method for an enhanced security check that involves providing the detailed security data of a network to a user device, according to some embodiments of the present disclosure.

FIG. 9 depicts an example computing device configured to perform various aspects of the present disclosure, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure provides a method, including receiving, at a first network device, a request to authenticate connection of a user device to a network, retrieving, by the first network device, security data associated with the network, determining, by the first network device, that one or more security criteria are satisfied based on analyzing the security data associated with the network, and transmitting, by the first network device, a response to the user device, where the response instructs the user device to establish a connection with the network and does not disclose the security data.

Another embodiment presented in this disclosure provides a method, including receiving, at a first network device, a request to authenticate connection of a user device to a network, transmitting, by the first network device, a response to the user device, wherein the response comprises security data associated with the network, and upon receiving a confirmation from the user device to establish a connection with the network, proceeding to verify an identify of the user device.

Another embodiment presented in this disclosure provides a system that comprises one or more memories collectively storing computer-executable instructions, and one or more processors configured to collectively execute the computer-executable instructions and cause the system to receive, at a first network device, a request to authenticate connection of a user device to a network, retrieve, by the first network device, security data associated with the network, determine, by the first network device, that one or more security criteria are satisfied based on analyzing the security data associated with the network, and transmit, by the first network device, a response to the user device, wherein the response instructs the user device to establish a connection with the network and does not disclose the security data.

### EXAMPLE EMBODIMENTS

Embodiments of the present disclosure provide methods and technologies that integrate the evaluation of a network's security posture and reputation into the Open Roaming (OR) federation system.

Open Roaming (OR) is becoming increasingly popular as a mechanism to streamline access to wireless networks. The current OR system generally includes three components: access network providers (ANPs), which are configured to manage and provide access to the wireless networks (e.g., a Wi-Fi hotspot); an identity provider (IdP), which is configured to authenticate a user's credentials and return a response to the ANP when the user is valid; and an OR federation that dynamically connects the ANP and the IdP. In some embodiments, the IdP may store the user's credentials in a cloud service, and supply admission data (and other information) to the ANP to ensure appropriate user servicing.

However, the present OR system lacks the capability of informing user devices about the security status or reputation of the wireless network (or the ANP) they are attempting to connect to. While some ANPs deploy measures to enhance WLAN security, many do not. For ANPs that lack such protections, the network may be insecure and vulnerable to attacks. Devices connecting to these vulnerable networks are at an increased risk of exposure, making them vulnerable to unauthorized access, data breaches, or other types of security threats. Additionally, the networks themselves may be used as launch points for a wider attack. As used herein, the reputation of an ANP may directly be related to the security equipment and/or measures utilized by the ANP, user engagement data with the wireless network, and other relevant attributes. In some embodiments, the security equipment and/or measures may include (without limitation) web filtering, firewalling, prevention of guest-to-guest connections, and detection and prevention of malicious threats (e.g., Man-in-the-Middle (MiTM) attacks, relays, poisoning, and others). In some embodiments, the user engagement data may include user feedback and reviews, historical user behaviors (e.g., misuse of the network for illegal activities), the active user base, historical usage records (e.g., session duration, frequency of connection, or the amount of data transferred), and the like.

An absence of transparent security or reputation metrics for a wireless network (or the ANP) in the existing OR framework may lead a user device to inadvertently connect to (or send authorization requests) to malicious or compromised networks, which puts both the data and the device at potential risk. Many users, if aware of the risk, may prefer to avoid joining a network where attacks on their devices are more likely. Many organizations that prioritize data security and integrity may implement strict policies around network access. These policies may prohibit connections to unidentified or potentially unsecure networks, especially when the connecting device is a company-provided asset.

To address these concerns and bridge the gap in the current OR framework, embodiments of the present disclosure provide methods and techniques that enable the OR federation or the IdP to retrieve, evaluate, and/or transmit the ANP's reputation/security data to the user device before any connection between the ANP and the user device is established. The disclosed methods ensure that the user device, the IdP, and the identity federation are aware of the ANP's reputation or security status before initiating the connection process. By exposing the reputation/security data to the users, the disclosed methods reduce the chance of user devices unknowingly or accidentally connecting to potentially compromised networks, thereby enhancing the overall user security in the OR system.

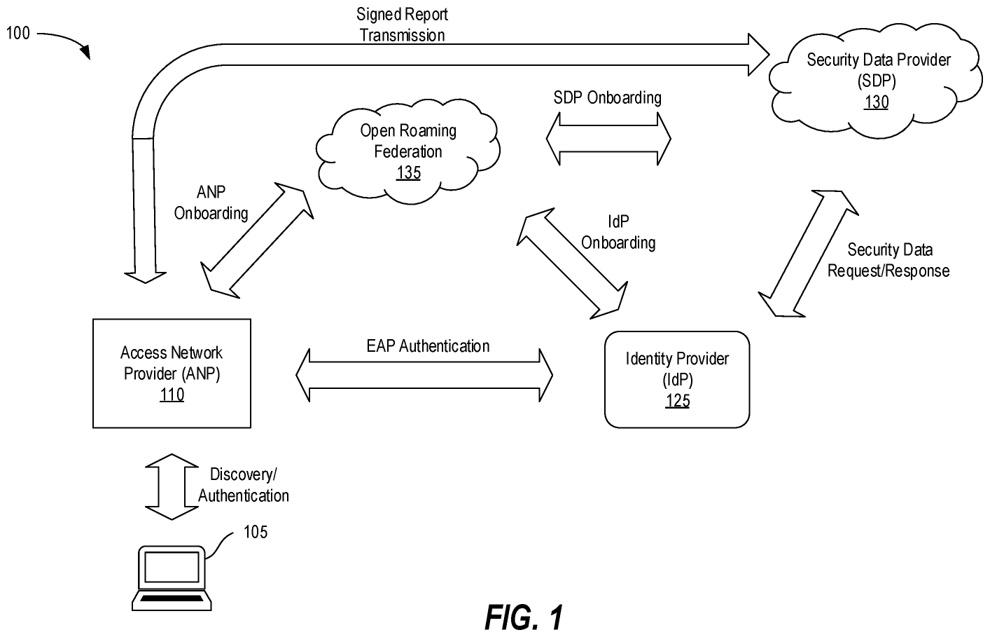

FIG. 1 depicts an example of the Open Roaming (OR) framework 100 that supports security enhancements, according to some embodiments of the present disclosure. The illustrated Open Roaming (OR) framework 100 comprises five main entities: the user device 105, the access network provider (ANP) 110, the identity provider (IdP) 125, the OR federation 135, and the security data provider (SDP) 130.

The OR framework is based on a public-key infrastructure trust model. Both the ANP 110 and the IdP 125 register and onboard with the identity federation 135, and upon successful registration, the ANP 110 and the IdP 125 obtain PKI-based certificates (e.g., X.509 certificates). These certificates are then used for secure tunnel establishments and validations.

In the illustrated example, the ANP 110 is configured to manage and provide access to a wireless network. In the illustrated example, the ANP 110 actively interacts with the user device 105 to facilitate the network discovery and authentication processes. In some embodiments, the ANP 110 may broadcast beacon signals (e.g., service set identifiers (SSIDs) for its associated wireless network) to the user device 105. The broadcasted signals may enable the user device 105 to be aware of and detect the available networks within its proximity. When the user device 105 identifies the network (managed by the ANP 110) and intends to establish a connection, the user device 105 may send an authentication request to the ANP 110. In some embodiments, the authentication request may include the user's credentials, such as a username and password, or other identifier for multi-factor authentication (e.g., token, certificate). The ANP 110, instead of processing the authentication by itself, may forward the request (along with the user's credentials) to the IdP via an established Extensible Authentication Protocol (EAP) authentication channel.

In the illustrated example, the IdP 125 is configured to process and authenticate the user's credentials forwarded by the ANP 110 during the authentication process. In some embodiments, the IdP 125 may maintain a database or have access to repositories that store a user's credentials and related information, such as usernames, passwords, certificates, tokens, or other authentication mechanisms. When the IdP 125 receives an authentication request, it may query the database to retrieve the stored credentials corresponding to the received username or identifier. The IdP 125 may then compare the credentials received in the request with the stored credentials to determine the authenticity and validity of the user or device trying to access the network (managed by the ANP 110), such as whether the user or device has the appropriate permission or rights to access the requested network, or whether the information associated with the user or device (e.g., profile data) is consistent with the records.

In the illustrated example, the OR federation 135 (also referred to in some embodiments as identity federation) provides a secure mechanism for integrating the ANP 110 and the IdP 125. Through successful onboarding of participating entities (both ANPs and IdPs), the OR federation 135 ensures that registered entities are recognized and trustworthy within the OR framework. In some embodiments, the certificate issued to the registered ANP 110 and IdP 125 may be used to facilitate secure communication channels (e.g., the EAP authentication channel) between the two entities, which allows them to exchange authentication requests/responses and security data (e.g., security profile or reputation score) associated with the requested network.

In the illustrated example, the service data provider 130 is a specialized entity dedicated to collecting, maintaining, and transmitting security-related data about various wireless networks (e.g., ANPs). The security data collected for each network (or ANP) may include a wide range of parameters, including, but not limited to, the security equipment or features implemented, encryption methods utilized, security incidents, detected threats, user feedback or reviews, records of malicious user behaviors (e.g., misuse of the network for illegal activities), and historical usage data. In some embodiments, the security equipment or features may include web filtering, firewalling, prevention of guest-to-guest connections, and detection and prevention of malicious threats (e.g., MiTM attacks, relays, poisoning, and others). In some embodiments, the historical usage data may include the active user base, duration and frequency of connection, and/or the amount of data transferred. In some embodiments, the security data provider 130 may maintain a database that contains the security data for each network (or ANP). The database may serve as a centralized repository that allows the security data to be easily accessible and up-to-date. Based on the security data, in some embodiments, the service data provider 130 may use a variety of algorithms or operations to generate a reputation score for each network (or ANP). The reputation score may include numeric values (e.g., ranging from 1 to 100), and may serve as a quick reference for users and/or the IdP 125 to determine the trustworthiness and security level of a specific network (or ANP).

In some embodiments, the security data provider 130 may be integrated into the OR federation. In some embodiments, the integration may be achieved through the use of Public Key infrastructure (PKI), where the security data provider 130 registers and onboards with the OR federation 135, and once successful, obtains PKI-based certificates (e.g., X.509 certificates). Under such configurations, the security data and/or the reputation score may be shared and readily accessible to other entities within the federation (e.g., the IdP 125). When a user device 105 sends an authorization request to connect to a network, the request may be forwarded by the ANP 110 to the IdP 125. Given the integrated nature of the security data provider 130 and the OR federation 135, the IdP 125 may access the security data and/or reputation score of the requesting ANP through an internal API service that designed for quick and secure data retrieval. In some embodiments, the integrated security data provider 130 may periodically update the database managed by the IdP 125. The periodic synchronization may ensure that the IdP always has the most up-to-date security data when performing network security evaluations.

In some embodiments, the service data provider 130 may operate independently (outside the OR federation system). Under such configurations, when the IdP 125 receives an authorization request from a requesting ANP 110, it may send an external API request to the service data provider 130 to retrieve the relevant security data and/or reputation score of the requesting ANP.

In some embodiments, the OR federation 135 and the ANP 110 may agree that, for the ANP 110 to be integrated into the OR federation 135, it must subscribe to the service provided by the security data provider 130. In some embodiments, the agreement may be part of the terms and conditions for ANP integration. This subscription may ensure that every ANP 110 within the OR federation is able to transmit a signed report detailing the ANP's security data and/or reputation score (provided by the security data provider 130) to a requesting user device 105 before any association is established.

Although the illustrated example emphasizes verifying/determining a network's security within the OR federation system, in some embodiments, the disclosed methods and techniques may be implemented in any system that uses a third party to verify/determine the security of a given network.

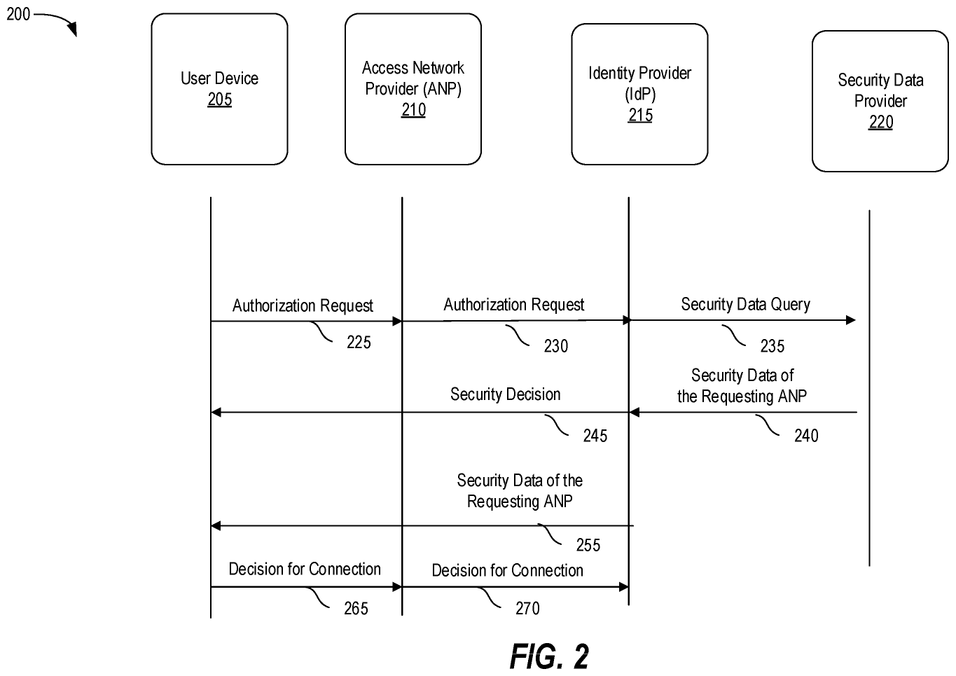

FIG. 2 is a diagram 200 depicting a sequence for retrieving and evaluating security data before connecting a user device to a federation-based network, according to some embodiments of the present disclosure.

In the illustrated diagram 200, upon detecting an available network, which is managed by the ANP 210, the user device 205 initiates the authentication process. For example, the user device 205 (which may correspond to the user device 105 of FIG. 1) sends an authentication request 225 to the ANP 210 (which may correspond to the ANP 110 of FIG. 1) using the EAP. In some embodiments, the authentication request 225 may be accompanied by a user's credentials, such as username/password, token, certificate, and the like.

Upon receiving the authentication request, the ANP 210 forwards it 230 to the IdP 215 (which may correspond to the IdP 125 of FIG. 1). In some embodiments, before forwarding the authentication request 225 to the IdP 215, the ANP 210 may check if the credential's format corresponds to one of the acceptable formats (e.g., username/password, token, certificate, etc.) that the IdP supports. In some embodiments, the ANP 210 may encapsulate the authentication request 230 to add any additional metadata that the IdP 215 may use to process the request efficiently.

The IdP 215 receives the authentication request 230 forwarded by the ANP 210. Before processing the authentication request (such as verifying the credential of the user device via the OR federation), the IdP 215 sends a query 235 to the security data provider 220 (which may correspond to the security data provider 130 of FIG. 1) to retrieve security data and/or reputation score associated with the ANP 210. In some embodiments, before sending the query 235, the IdP 215 may determine whether the security data provider 220 has been integrated into the OR federation system. If it is determined that the security data provider 220 has been successfully registered within the OR federation (e.g., 135 of FIG. 1), the IdP 215 may send the query 235 via an internal API service. Given the internal nature of the query within the federation, the integration of the security data provider 220 may allow for faster security data retrieval with reduced latency and improved security. In some embodiments, the integrated security data provider 220 may periodically synchronize the security data within the IdP's database. When receiving the authentication request, the IdP 215 may directly retrieve the security data associated with the requesting ANP 210 (or the network) from its database.

If the IdP 215 determines that the security data provider 220 is not part of the OR federation, it may communicate with the security data provider 220 using an external API request, which is transmitted outside the boundaries of the OR federation's infrastructure. In some embodiments, the external API request and/or response (which may include the security data of the requesting ANP) may be encrypted or signed to ensure the integrity and confidentiality of the data.

After sending the query 235 (either internal or external), the IdP 215 awaits the security data and/or reputation score from the security data provider 220. In some embodiments, the IdP 215 may set a timeout period to prevent infinite waiting of the IdP for the security data. When the IdP 215 does not receive the security data within the defined timeout period, it may determine that there is an error in the transmission. Based on the determination, the IdP 215 may notify system administrators, attempt to retry the query, and/or directly deny the authentication.

In the illustrated diagram 200, after the security data provider 220 receives the query 235, it retrieves and compiles the necessary security data and/or reputation score for the associated ANP 210, and transmits the data 240 back to the IdP 215. In some embodiments, the retrieval process may include aggregating the security data from various sources, and/or calculating and/or updating the reputation score to reflect the current security level of the ANP 210. In some embodiments, the security data 240 transmitted to the IdP 215 may be encrypted for enhanced security (especially when the security data provider 220 is external to the OR federation). In some embodiments, when the security data provider 220 encounters an error when retrieving the security data (e.g., network failures, database access issues), it may send an error message to the IdP 215, notifying the IdP about the problem. The error message may further include suggestions for retrying the query at a later time or other alternative actions.

The IdP 215 evaluates the security data and/or reputation score 240 provided by the security data provider 220. In the illustrated diagram, the IdP 215 may either evaluate the security data 240 and transmit a decision 245 to the user device or directly forward the detailed security data 255 to the user device without evaluating it internally.

In some embodiments, such as when the IdP 215 evaluates the security data 240, it may first check if a central policy (e.g., Mobile Device Management (MDM) or Group Policy) is applicable to the user device making the security decision 245. The central policy may define security requirements for the networks that the user device attempts to connect to, such as mandatory WPA3 encryption or multi-factor authentication enforcement. In some embodiments, the central policy may specify a reputation score threshold that the network must reach or exceed. Based on the central policy, the IdP 215 may evaluate whether the ANP's network satisfies the outlined requirements and/or if its reputation score reaches or exceeds the defined threshold. If the network's settings (e.g., security equipment/measures installed) do not meet the requirements or its reputation score falls below the threshold, the IdP 215 may decide to abort the connection, and communicate the denial decision 245 directly to the user device 205 or routed through the ANP 210. Alternatively, if the network's settings satisfy the requirements and/or its reputation score reaches or surpasses the threshold, the IdP 215 may decide to proceed with the authentication process and establish the connection. In some embodiments, the IdP 215 may communicate the approval decision 245 to the user device 205. In some embodiments, before proceeding with the authentication process (such as verifying the credential of the user device through the OR federation), the IdP 215 may further analyze the security data 240 to determine if a local policy of the user device has been satisfied.

In some embodiments where no central policy is applied to the user device 205, the IdP 215 may rely on its internal mechanisms to analyze the received security data and/or reputation score, and determine whether the requesting ANP 210 (or its network) offers a level of security sufficient for a connection. In some embodiments, the IdP may compare the security data and/or reputation score with a local policy defined by the user device 205. In some embodiments, the local policy may specify the security criteria that a network must fulfill for the user device 205 to establish a connection. In some embodiments, the IdP 215 may include some default security requirements that every network should meet before granting access.

If the defined criteria (either within the local policies or the IdP's default settings) are satisfied (such as that the ANP's reputation score exceeds a defined threshold), the IdP 215 may decide to initiate the authentication process and establish the connection. Otherwise, the IdP 215 may decide to abort the connection and transmit the decision 245 either directly to user device 205 or routed through the ANP 210. In some embodiments, the IdP 215 may convey its decision 245 to the ANP 210 through a message like “Access-Reject” if the connection is denied. In some embodiments, the decision 245 may also be communicated to the user device 205 by sending a Vendor-Specific Attribute (VSA) to the user device 205 in the Remote Authentication Dial-In User Service (RADIUS) exchange with a specific reason code. The decision 245 may first be sent to the ANP 210, and then forwarded by the ANP 210 to the user device 205.

In some embodiments, the IdP 215 may forward the detailed security data and/or reputation score 255 directly to the user device 205 without evaluating it internally. In some embodiments, the security data 255 may be transmitted directly to the user device 205 or routed through the ANP 210. In some embodiments, the reputation score of the ANP 210 may be transmitted through a VSA as part of the RADIUS exchange.

After receiving the security data 255, the user device 205 may evaluate the data against its local user policies. In some embodiments, the decision to abort or continue the authentication process may be generated automatically by comparing the security data with some predefined criteria (e.g., a threshold for the reputation score). In some embodiments, the decision may be made manually. For example, the user device 205 may display the received security data and/or reputation score to the user. Following that, the user device 205 may generate a pop-up window for the user, which offers options such as “Confirm to Connect,” “Disconnect,” or “More Information.”

The user device 205, after evaluating the security data 255, communicates the decision 265 (which instructs the IdP to either continue or abort the authentication process) to the ANP 210. The ANP 210 then forwards the decision 270 to the IdP 215. In some embodiments, the decision may be sent to the IdP 215 using a VSA within the RADIUS exchange. In some embodiments, the IdP 215 may interpret the received decision to determine the next step within the authentication process. For example, if the decision indicates a continuation of the authentication process, the IdP 215 may move to verify the credentials of the user device (by querying its database). Upon successful verification, a connection of the user device 205 to the network managed by the ANP 210 may be established. If the decision indicates a denial, the IdP 215 may halt any further authentication procedures for the specific request 225. In some embodiments, the IdP 215 may log the denial for future reference and analysis. In some embodiments, the IdP 215 may define an alert threshold for the denial rate. When the denial rate for a specific ANP exceeds the alert threshold, the IdP 215 may send an alert to the OR federation (e.g., 135 of FIG. 1), indicating potential security issues or risks associated with the ANP.

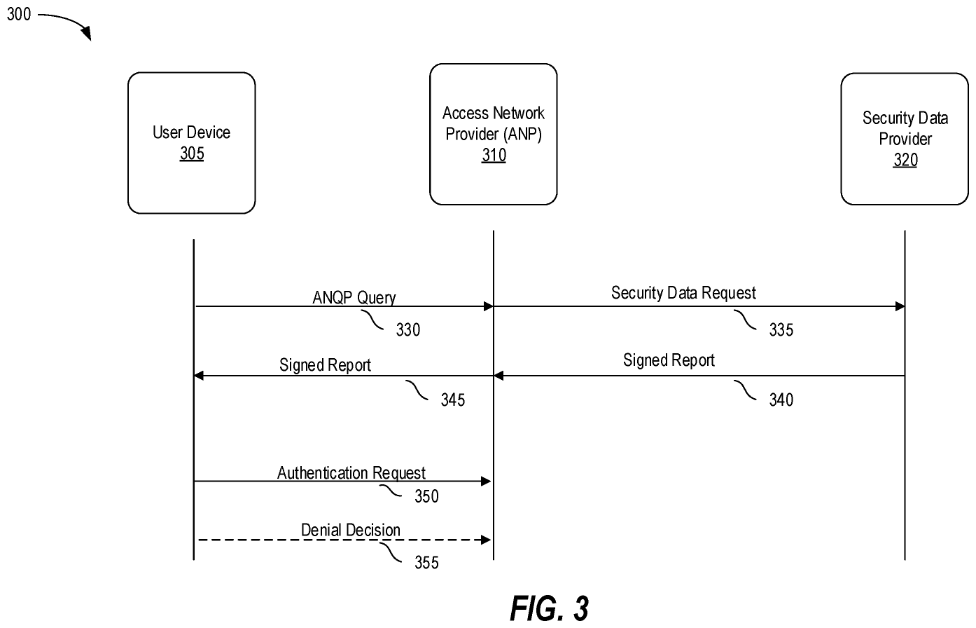

FIG. 3 is a diagram 300 depicting a sequence for retrieving and evaluating a signed security report before connecting a user device to a federation-based network, according to some embodiments of the present disclosure.

In the illustrated diagram 300, the security data provider 320 (which may correspond to the security data provider 130 of FIG. 1) is integrated into the OR federation, and the ANP 310 (which may correspond to the ANP 110 of FIG. 1) directly subscribes to the services provided by the security data provider 320 (e.g., transmitting signed security reports for associated networks upon request).

The user device 305 (which may correspond to the user device 105 of FIG. 1) detects one or more available networks managed by the ANP 310. Before initiating the authentication process, the user device 305 sends a query 330 to the ANP 310, requesting the ANP 310 to provide security information associated with the available networks. In some embodiments, the query 330 may be transmitted using Access Network Query Protocol (ANQP).

The ANP 310, upon receiving the ANQP query 330, communicates with the security data provider 320 (to which it subscribes) to retrieve the up-to-date signed security report associated with the ANP (or its network). The communication may include transmitting a security data request 335 (e.g., an API call) to the security data provider 320 to obtain the required data. In some embodiments, the signed security report may refer to a document issued by the security data provider 320 that includes an overview of a network's security posture. The report may be cryptographically signed by the security data provider 320 to ensure authenticity and data integrity. The content within the report may include, but is not limited to, encryption standards, installed security equipment and/or features (e.g., firewalls, intrusion detection system, web filters, systems of preventing guest-to-guest connections, anti-malware tools), authentication measures (e.g., multi-factor authentication), historical usage records, user feedback/reviews, records for past breaches (e.g., threats or attacks the network previously encountered), and the like. In some embodiments, the signed security report may also include a reputation score that is calculated based on the aforementioned security attributes. The reputation score may provide a quick reference to evaluate the network's security level.

The ANP 310 retrieves the signed security report 340 from the security data provider 320, and then transmits it 345 to the user device 305 in response to the ANQP query 330. The security report 340 may include a digital signature provided by the security data provider 320. The signature may serve to ensure the authenticity (which confirms that the report originates from the security data provider) and integrity (which confirms that the content within the report has not been altered after its issuance by the security data provider) of the issued report. Upon receiving the report, the user device 305 uses the public key (obtained from the OR federation profile) to validate the signature of the report. If the ANP or any other entity attempts to change the report, the signature validation will fail, which indicates potential data integrity issues to the user device.

After the signature has been verified, the user device 305 evaluates the received security data (and/or reputation score), and compares it with local policies or user-defined criteria. In some embodiments, the evaluation may involve checking if the security measures implemented by the ANP meet the defined standards, or if the reputation score is equal to or above a defined threshold.

Based on the evaluation, the user device 305 (which may correspond to the user device 105 of FIG. 1) may decide whether to initiate the authentication process. In some embodiments, the decision may be made automatically. For example, if the security data satisfy the defined criteria (or the reputation score is equal to or above the threshold), the user device may proceed to send an authentication request 350 to the ANP 310. If the security data does not meet the criteria (or the reputation score is below the threshold), the device may optionally send a denial decision 355 to the ANP 310 (as depicted by a dashed arrow), which notifies the ANP 310 that the user device 305 will not proceed with authentication. In some embodiments, the decision to either terminate or initiate a connection with the network may be determined manually by the user. For example, the user device 305 may display the signed security report to the user. To support the user to make an informed decision, in some embodiments, the user device 305 may provide a side-by-side comparison of the security data and/or associated reputation score within the report against predefined criteria. The visual representation may also include options such as “Confirm to Connect” and “Disconnect,” prompting the user to make a final decision on the connection. If the user selects “Confirm to Connect,” the user device 305 may then proceed to transmit an authentication request 350 to the ANP 310, initiating the connection process. If the user opts for “Disconnect,” the user device 305 may terminate any preliminary connection process, and optionally send a notification 355 to the ANP 310.

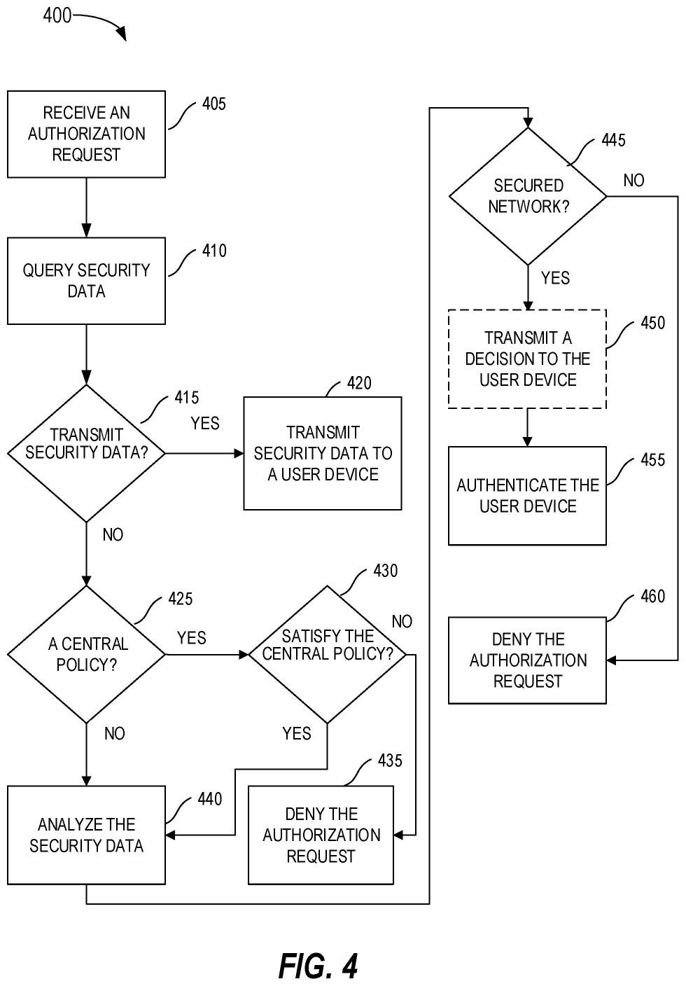

FIG. 4 depicts an example method 400 for assessing a network's security data by an Identity Provider (IdP), according to some embodiments of the present disclosure. In some embodiments, the method 400 may be performed by an IdP that supports enhanced security evaluation, such as the 125 of FIG. 1, and the 215 of FIG. 2.

The method 400 begins at block 405, where an IdP (e.g., 125 of FIG. 1) receives an authentication request. In some embodiments, the authentication request may originate from a user device (e.g., 205 of FIG. 2) that intends to connect to a network managed by an ANP (e.g., 210 of FIG. 2). Upon processing the request, the ANP may then forward it to the IdP for further evaluation. In some embodiments, the authentication request may include various information, such as a unique identifier of the user device (which represents the specific user device trying to connect) (e.g., MAC address, device name), the user's credentials (e.g., username/password, tokens, certificate), prior session IDs if the user device had previously connected, and/or requested network service (e.g., bandwidth, latency). In some embodiments, based on the information contained in the authentication request, the IdP may identify the type of network the user device is attempting to connect to, such as a public Wi-Fi hotspot or a corporate network. In some embodiments, upon receiving the authentication request, the IdP may send an initial acknowledgement to the user device, which notifies the user device that the request has been received and is being processed.

At block 410, the IdP queries a security data provider (e.g., 220 of FIG. 2) to retrieve the relevant security data of the requesting ANP (or its network). In some embodiments, the query process may be initiated by the IdP transmitting a security data request (e.g., 235 of FIG. 2) to the security data provider. The request may include specific parameters about the network, such as the network's identifier, type, location, and other relevant details. In response to the request, the security data provider may process the parameters and send back the relevant security data (e.g., 240 of FIG. 2) to the IdP. In some embodiments, the security data may include various information related to the requesting ANP (or its network), such as the security features implemented, the encryption standards utilized, historical usage records, user feedback/review, and/or a generated reputation score. In some embodiments, the information may allow the IdP to make an informed decision about the user device's connection request. In some embodiments, such as when the security data provider fails to retrieve the relevant security data (e.g., due to network failure), it may transmit an error message to the IdP, indicating the potential failures. In some embodiments, the IdP may set up a timeout mechanism to handle situations where the security data provider does not respond in a timely manner or receives an error message. When the timeout mechanism is triggered (either by not receiving the security data timely or receiving the error message indicating the retrieval failure), the IdP may attempt to resend the query at a later time or take other appropriate actions (e.g., log the incident for reviews, directly denies the authentication request).

In some embodiments, at block 410, the IdP may further check if the security data provider is part of the OR federation-based system, where the security data provider has been successfully registered within the OR federation (e.g., 135 of FIG. 1), and a relevant PKI-based certificate has been obtained. If the security data provider has been integrated, the query may be transmitted through an internal API call. Alternatively, if the security data provider operates independently (outside the OR federation), the query may be implemented externally, using standardized API calls or other set protocols.

At block 415, the IdP, after receiving the relevant security data, determines whether to evaluate the security data directly or transmit the data to the user device for further analysis. A variety of factors may be considered in making such a decision, including but not limited to the IdP's setting, the nature of the user device, and/or the user preference. In some embodiments, there may be some internal policies and/or external regulatory requirements that request the IdP to handle the evaluation of security data. To comply with the policies and/or regulations, the IdP may be set up to evaluate the security data (without forwarding the data to the user device) and make a related decision (e.g., whether the requesting ANP or its network is secure or not). In some embodiments, the user device may lack the capacity to process the security data and/or display the data efficiently and accurately to users, and therefore the evaluation by the IdP may be preferred. In some embodiments, the user may specify certain preferences or policies on their devices regarding how the security evaluation should be conducted. For example, in some embodiments, these policies may indicate that the user device should be involved in the decision-making process, and the security data should be communicated to the use device. Alternatively, in some embodiments, users may trust the IdP more and may not want the devices to handle sensitive security evaluations. In such configurations, the security data should be analyzed by the IdP without being forwarding to the user device.

If the IdP decides that the security data should be transmitted to the user device for evaluation and determination (due to the IdP's setting, the capability of the user device, and/or user's preference), the method 400 proceeds to block 420, where the IdP transmits the security data (e.g., 255 of FIG. 2) to the user device. If it is determined that the security data should be evaluated by the IdP, the method 400 proceeds to block 425.

At block 425, the IdP checks its settings (or a centralized policy management system) to determine if there is a central policy that applies to the user device (or the network the device is trying to connect to). In some embodiments, the central policy may include specific requirements that the requesting ANP (or its network) must meet in order for the user device to join. These requirements may range from basic measures (e.g., WPA3 encryption, multi-factor authentication) to more advanced security protocols or features. In some embodiments, as discussed above, the central policy may also define a minimum threshold for a reputation score. If such a central policy exists, the method 400 proceeds to block 430, where the IdP analyzes the received security data to determine whether the requirements of the central policy have been met. If the IdP determines that no central policy is applicable to the user device (or the network), the method 400 proceeds to block 440.

At block 430, the IdP determines whether the central policy has been satisfied. For example, in some embodiments, the IdP may determine whether the security measures of the requesting ANP (or its network) reach the criteria or standards set forth in the central policy. In some embodiments, the IdP may compare the ANP's reputation score with the defined minimum threshold. If it is determined that the central policy has not been met, the method 400 moves to block 435, where the IdP denies the authentication request, and/or sends a decision to the user device. In some embodiments, the denial decision (e.g., 245 of FIG. 2) may be transmitted to the user device using a VSA in the RADIUS exchange. If, however, the IdP determines that the central policy has been satisfied, the method 400 proceeds to block 440, where the IdP further evaluates the security data to determine if the network provides sufficient security by comparing it with local policies or default settings. In some embodiments, the user device may define particular security and/or connection requirements based on its unique needs or preferences. For example, a user may set up their devices to only connect to networks that offer multi-factor authentication or have a reputation score equal to or above a certain threshold. In corporation settings, the organization may set local policies for company-owned devices to ensure they only connect to networks that align with the organization's security protocols. These requirements may be outlined in the local policies to ensure secure and compliant network connections. In some embodiments, in the absence of a local policy, the IdP itself may have some default security requirements/settings that it expects any network to meet before granting access. The default requirements/settings may include a minimum required reputation score or certain mandatory security measures that need to be implemented.

At block 445, the IdP determines whether the network (or the requesting ANP) is sufficiently secure for the user device to connect to. As discussed above, the assessment may involve comparing the received security data with the user-specific policies (also referred to in some embodiments as local policies). If such policies do not exist, the IdP may resort to tis default settings for comparison. If the evaluation leads the IdP to determine that the network is insecure or compromised (e.g., based on the determination that the local policies or default settings are not satisfied), the method 400 proceeds to block 460, where the IdP denies the authentication request. The decision (with the specific reason for denial) may be then transmitted to the user device. In some embodiments, a VSA in the RADIUS exchange may be used to convey the denial decision.

If the analysis leads the IdP to determine that the network is sufficiently secure, the method proceeds to block 450, where the IdP transmits a positive decision (e.g., 245 of FIG. 2) to the user device. The decision may indicate that the user device can safely connect to the network without compromising its security. The positive decision may be transmitted by using a VSA in the RADIUS exchange. The transmission of the positive decision to the user device is optional (e.g., indicated by the dashed line at block 450). In some embodiments, upon determining that the network is sufficiently secure, the method 400 may move directly to block 455, where IdP initiates the authentication process. For example, in some embodiments, the IdP may verify the credentials of the user device (provided in the authentication request) via the OR federation. These credentials may be in the form of usernames/passwords, digital certificates, tokens, and the like. The verification aims to ensure the user device is permitted to access the requested network resources. In some embodiments, such as when multi-factor authentication is required, the IdP may verify more than one form of identity (provided by the user device) before granting access. After successful authentication, the IdP may communicate the results to the ANP (and optionally to the user device). Based on the results, the ANP may then allow the user device to connect to the network and allocate necessary resources (e.g., IP addresses, bandwidth allocation) to the user device.

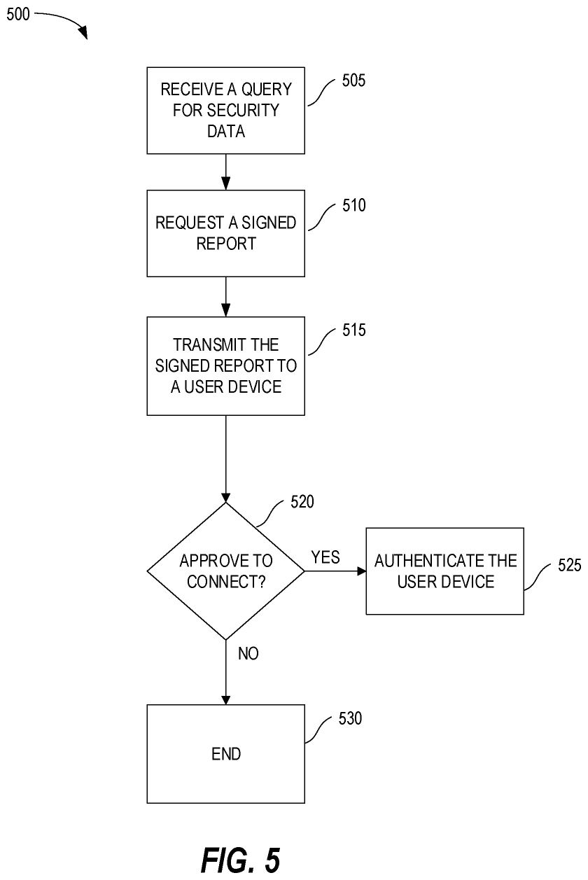

FIG. 5 depicts an example method 500 for querying and transmitting a network's signed security report by an access network provider (ANP), according to some embodiments of the present disclosure. In some embodiments, the method 500 may be performed by an ANP that supports enhanced security evaluation, such as the 110 of FIG. 1, and the 310 of FIG. 3.

At block 505, an ANP (e.g., 310 of FIG. 3) receives a query from a user device (e.g., 305 of FIG. 3), which requests the ANP to fetch the security data associated with the network it currently manages (the network that the user device is interested in joining). In some embodiments, the query may be communicated using the ANQP or other communication protocols. The query may include various information, such as the identifier (e.g., Service Set Identifier (SSID)) of the network that the device intends to connect to, the MAC address of the user device, details of previous successful connection, and the like.

At block 510, the ANP processes the received query, and generates a request to the security data provider (e.g., 320 of FIG. 3). The request (e.g., 335 of FIG. 3) may include the data within the query (e.g., the network identifier, the MAC address of the user device) and any supplemental information that the ANP considers necessary for the security data provider to generate the appropriate security report. In some embodiments, such as when the security data provider is integrated into the OR federation, the communication for transmitting the request may be through an internal API channel.

At block 515, the ANP receives a signed report (e.g., 340 of FIG. 3) from the security data provider, and then forwards it (e.g., 345 of FIG. 3) to the user device. In some embodiments, the security report may be cryptographically signed by the security data provider using its private key, and the resulting encrypted hash (also referred to in some embodiments as the digital signature) is attached to the report. The user device, upon receiving the report, may verify the report's authenticity and integrity using the public key of the security data provider. As discussed above, the security report may provide a comprehensive review of the security and reliability of the network (or the ANP), and may include various information, such as the implemented security features/equipment, the supported encryption protocols, the authentication measures, historical usage records, user feedback/reviews, and records for past breaches. In some embodiments, the report may also include a metric (e.g., a reputation score) that provides a direct representation of the network's security level.

At block 520, the ANP receives a decision from the user device. The decision may indicate whether the user approves of continuing the connection process with the network managed by the ANP. If the decision approves the continuation of the connection (e.g., indicated by transmitting an authentication request) (e.g., 350 of FIG. 3), the method 500 moves to block 525, where the ANP proceeds with the authentication process. For example, in some embodiments, the ANP may forward the authentication request (received from the user device) to the IdP (e.g., 125) to verify the user's credentials via the OR federation (e.g., 135 of FIG. 1). If the decision denies the continuation of the connection (e.g., indicated by optionally transmitting a denial decision to the ANP) (e.g., 355 of FIG. 3), the method 500 moves to block 530, where the security evaluation process ends.

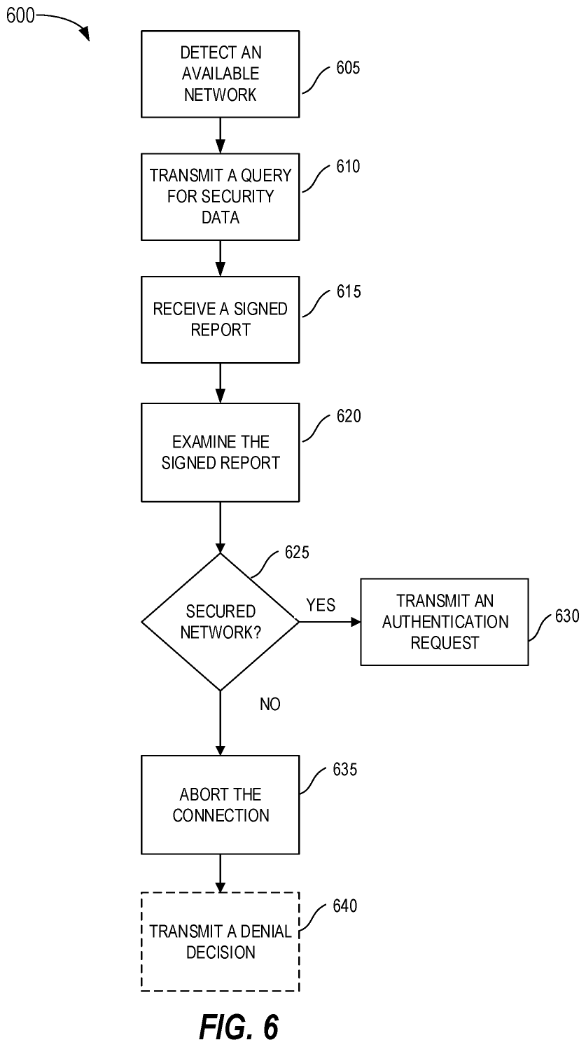

FIG. 6 depicts an example method 600 for evaluating a network's signed security report by a user device, according to some embodiments of the present disclosure. In some embodiments, the method 600 may be performed by a user device that supports enhanced security evaluation, such as the 105 of FIG. 1, and the 305 of FIG. 3.

At block 605, a user device (e.g., 305 of FIG. 3) actively scans its surroundings for available networks. After detecting a network, the user device determines its type (e.g., public Wi-Fi hotspot, a corporate network) and recognizes the network as being managed by an ANP (e.g., 310 of FIG. 3).

At block 610, the user device proceeds to gather more detailed security information about the detected network. For example, in some embodiments, the user device may transmit a query (e.g., 330 of FIG. 3) to request the data from a third-party service provider (e.g., the security data provider 315 of FIG. 3). In some embodiments, the query may be generated using protocols like ANQP. In some embodiments, the query may include some metadata about the device and the network it intends to connect to, such as the network SSID, the MAC address of the user device, and the like. In some embodiments, the query may include a timestamp to verify that the response is received on time and/or corresponds specifically to the sent query. To further improve security and prevent eavesdropping, in some embodiments, the query may be encrypted using protocols or methods agreed upon between the user device and the ANP.

At block 615, the user device receives the signed security report from the ANP. As discussed above, the signed security report may contain details about the network's security. In some embodiments, the third-party service provider (e.g., the security data provider 315 of FIG. 3) may use its private key to cryptographically sign the security report, and the produced signature is attached to the report and transmitted to the user device. In some embodiments, before processing the security data provided, the user device may first verify the report's signature using the service provider's public key. The verification ensures the authenticity of the report's source and its integrity (e.g., that the report has not been altered during transmission). In some embodiments, such as when the security data provider has been successfully registered within the federation, the public key of the security data provider may be found within the OR federation profile. In some embodiments, the user device may check the timestamp of the report to ensure it is received in a timely manner.

At block 615, the user device examines the security data within the report. For example, the user device may compare the security data from the report against predefined requirements or criteria (e.g., local policies). In some embodiments, the defined requirements may specify the essential security features/equipment that need to be implemented (e.g., firewalling, prevention of guest-to-guest connections), the required authentication methods (e.g., multi-factor authentication), the supported encryption standards, and the like. In some embodiments, the requirements may define a minimum reputation score that the network must achieve or maintain.

At block 625, the user device determines whether the network is sufficiently secure. In some embodiments, the user device may generate the decision automatically by comparing the security data with the defined requirements or minimum reputation score. In some embodiments, instead of making an automated decision, the device may display the security data or metrics and their comparison results against the requirements to the user. The presentation may highlight the key metrics, areas where the network's status meets or diverges from the preferred standards, and/or potential risks or threats. In some embodiments, the device may pop up a window, which asks the user to make a decision. The interface window may include options like “Connect,” “Disconnect,” “More Information.” The displayed options allow the user to make an informed decision based on the presented data. If the user device (either automatically or manually) determines that the available network is sufficiently secure (e.g., based on the determination that the requirements have been met or the network's reputation score is equal to or above the minimum threshold), the method 600 moves to block 630, where the user device initiates the connection process by transmitting an authentication request (e.g., 350 of FIG. 3) to the ANP. If the user device determines that the network is insecure or compromised (e.g., based on the determination that the requirements have not been satisfied or the network's reputation score falls below the minimum threshold), the method 600 proceeds to block 635, where the user device aborts the connection. In some embodiments, after determining to abort the connection, at block 640, the user device may optionally transmit a denial decision to the ANP, notifying the ANP of the decision not to proceed with the connection.

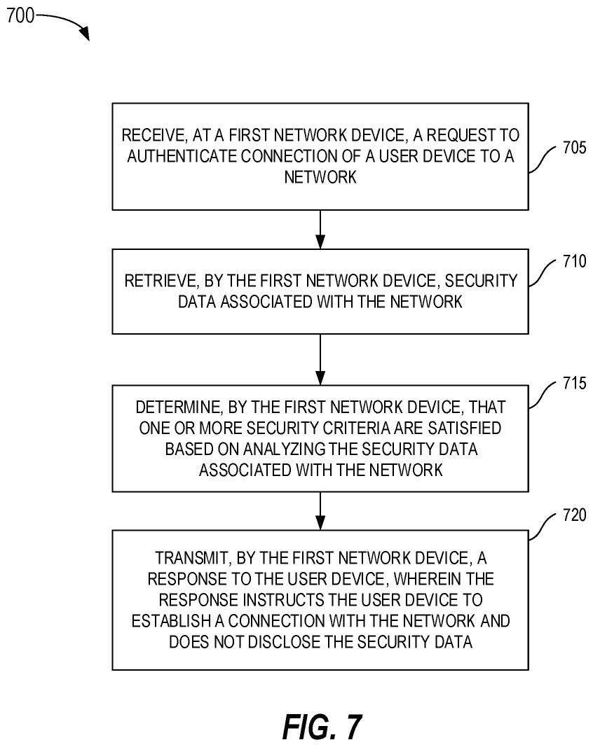

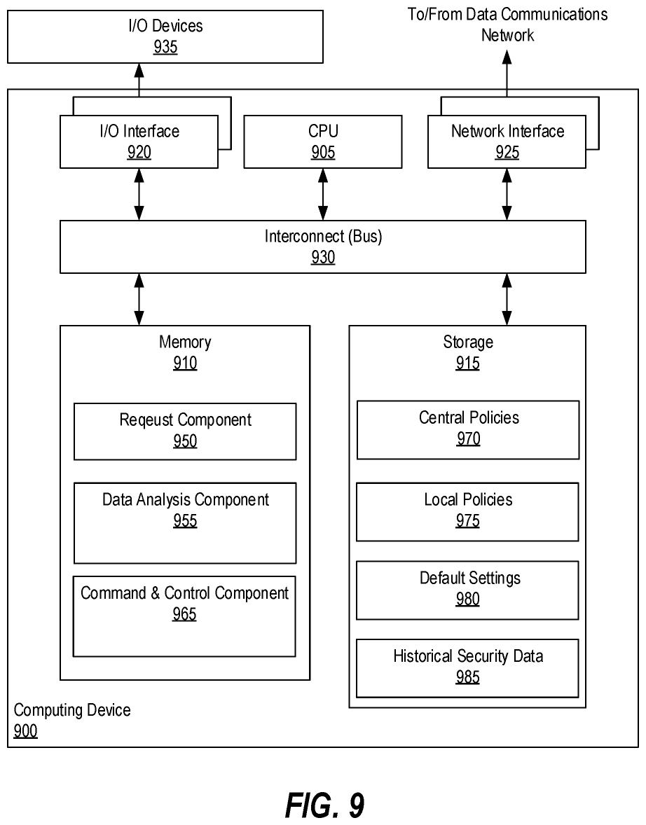

FIG. 7 is a flow diagram depicting an example method 700 for an enhanced security check without disclosing the detailed security data of a network to a user device, according to some embodiments of the present disclosure. In some embodiments, the method 700 may be performed by an IdP that supports enhanced security evaluation, such as the IdP 125 of FIG. 1, the IdP 215 of FIG. 2, and the computing device 900 of FIG. 9.

At block 705, a first network device (e.g., 215 of FIG. 2) receives a request (e.g., 230 of FIG. 2) to authenticate connection of a user device (e.g., 205 of FIG. 2) to a network. In some embodiments, the first network device may comprise an identify provider (IdP) that authenticates user devices based on one or more authentication protocols, and the request may be received from an access network provider (ANP) (e.g., 210 of FIG. 2) that manages connections between user devices and the network.

At block 710, the first network device retrieves security data associated with the network (e.g., 240 of FIG. 2). In some embodiments, the security data associated with the network may be retrieved from a second network device (e.g., 220 of FIG. 2), and the second network device may be integrated into a federation-based system that comprises the IdP and the ANP, and periodically synchronize the security data associated with the network within a database of the federation-based system. In some embodiments, the security data associated with the network may be retrieved from a second network device (e.g., 220 of FIG. 2), and the second network device may comprise an application programming interface (API) service. In some embodiments, the process of retrieving the security data associated with the network may comprise transmitting, by the IdP, structured API calls (e.g., 235 of FIG. 2) to the second network device, in order to retrieve the security data associated with the network.

In some embodiments, the security data associated with the network (e.g., 240 of FIG. 2) may comprise at least one of (i) a reputation score of the network, or (ii) a security profile of the network.

In some embodiments, the process of determining that the one or more security criteria are satisfied may comprise determining, by the first network device (e.g., 215 of FIG. 2), that a reputation score associated with the network exceeds a defined threshold.

At block 715, the first network device determines that one or more security criteria are satisfied based on analyzing the security data associated with the network.

At block 720, the first network device transmits a response (e.g., 245 of FIG. 2) to the user device, where the response instructs the user device to establish a connection with the network and does not disclose the security data.

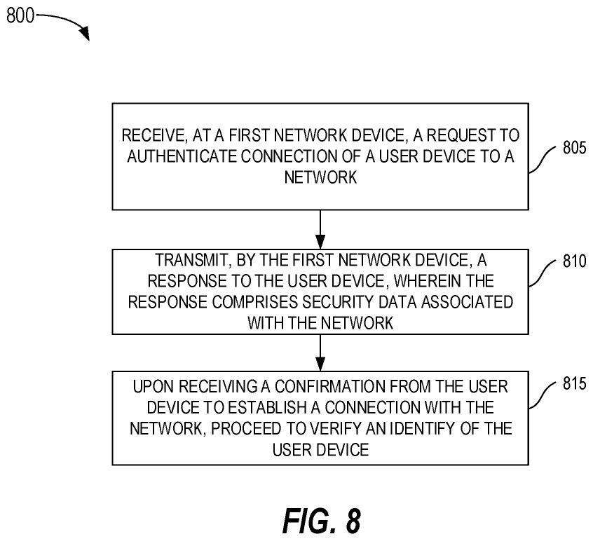

FIG. 8 is a flow diagram depicting an example method 800 for an enhanced security check that involves providing the detailed security data of a network to a user device, according to some embodiments of the present disclosure. In some embodiments, the method 800 may be performed by an IdP that supports enhanced security evaluation, such as the IdP 125 of FIG. 1, the IdP 215 of FIG. 2, and the computing device 900 of FIG. 9. In some embodiments, the method 800 may be performed by an ANP that supports enhanced security evaluation, such as the ANP 110 of FIG. 1, and the ANP 310 of FIG. 2.

At block 805, a first network device (e.g., 215 of FIG. 2) receives a request to authenticate connection of a user device to a network.

At block 810, the first network device transmits a response (e.g., 255 of FIG. 2) to the user device, where the response comprises security data associated with the network.

At block 815, the first network device, upon receiving a confirmation (e.g., 265 and/or 270 of FIG. 2) from the user device to establish a connection with the network, proceeds to verify an identify of the user device.

In some embodiments, the first network device may comprise an access network provider (ANP) (e.g., 310 of FIG. 3) that manages connections between user devices and the network. In some embodiments, the security data associated with the network within the response comprises a reputation score (e.g., 340 of FIG. 3) that is cryptographically signed by a second network device (e.g., 320 of FIG. 3). In some embodiments, the user device, upon receiving the reputation score, may verify an integrity of the reputation score using a public key associated with the second network device. In some embodiments, the user device may compare the reputation score with a defined threshold, and upon determining that the reputation score exceeds the defined threshold, transmit the confirmation (e.g., 350 of FIG. 3) to the first network device, where the confirmation instructs the first network device to establish the connection with the network.

In some embodiments, the first network device may comprise an identify provider (IdP) (e.g., 215 of FIG. 2) that authenticates user devices based on one or more authentication protocols, and the request may be received from an access network provider (ANP) (e.g., 210 of FIG. 2) that manages connections between user devices and the network. In some embodiments, the first network device (e.g., 215 of FIG. 2), prior to transmitting the response to the user device, may retrieve the security data associated with the network (e.g., 240 of FIG. 2) from a second network device (e.g., 220 of FIG. 2). In some embodiments, the security data associated with the network within the response (e.g., 245 of FIG. 2) comprises at least one of (i) a reputation score of the network, or (ii) a security profile of the network. In some embodiments, the user device (e.g., 205 of FIG. 2), upon determining that one or more security criteria are satisfied, may transmit the confirmation (e.g., 265 of FIG. 2) to the first network device, and the confirmation may instruct the first network device to establish the connection with the network.

FIG. 9 depicts an example computing device 900 configured to perform various aspects of the present disclosure, according to one embodiment. Although depicted as a physical device, in embodiments, the computing device 900 may be implemented using virtual device(s), and/or across a number of devices (e.g., in a cloud environment). In one embodiment, the computing device 900 may correspond to an IdP that supports enhanced security evaluation, such as the IdP 125 of FIG. 1, and the IdP 215 of FIG. 2. In some embodiments, the computing device 900 may correspond to a user device that supports enhanced security evaluation, such as the user device 105 of FIG. 1, the user device 205 of FIG. 2, and the user device 305 of FIG. 3.

As illustrated, the computing device 900 includes a CPU 905, memory 910, storage 915, one or more network interfaces 925, and one or more I/O interfaces 920. In the illustrated embodiment, the CPU 905 retrieves and executes programming instructions stored in memory 910, as well as stores and retrieves application data residing in storage 915. The CPU 905 is generally representative of a single CPU and/or GPU, multiple CPUs and/or GPUs, a single CPU and/or GPU having multiple processing cores, and the like. The memory 910 is generally included to be representative of a random access memory. Storage 915 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 935 (such as keyboards, monitors, etc.) are connected via the I/O interface(s) 920. Further, via the one or more network interfaces 1025, the computing device 1000 can be communicatively coupled with one or more other devices and components (e.g., via a network, which may include the Internet, local network(s), and the like). As illustrated, the CPU 905, memory 910, storage 915, network interface(s) 925, and I/O interface(s) 920 are communicatively coupled by one or more buses 930. The network interface 925 connects to a wireless communication network (e.g., a network following the IEEE 802.11 standard) via one or more antennas.

In the illustrated embodiment, the memory 910 includes a request component 950, a data analysis component 955, and a command & control component 960, which may perform one or more embodiments discussed above. Although depicted as discrete components for conceptual clarity, in embodiments, the operations of the depicted components (and others not illustrated) may be combined or distributed across any number of components. Further, although depicted as software residing in memory 910, in embodiments, the operations of the depicted components (and others not illustrated) may be implemented using hardware, software, or a combination of hardware and software.

In some embodiments, such as when the computing device 900 corresponds to an IdP that supports enhanced security evaluation, the request component 950 may be configured to generate a security data query (e.g., 235 of FIG. 2) in response to an authentication request (e.g., 230 of FIG. 2) received from a user device (e.g., 205 of FIG. 2). The query may be used to request the security data associated with the network (or the ANP) that the user device is trying to connect to. In some embodiments, the query may include information such as the SSID of the network, the MAC address of the user device, and other supplemental data that helps a third-party service provider (e.g., 220 of FIG. 2) to locate and retrieve the requested security data. In some embodiments, the data analysis component 955 within the IdP may be configured to evaluate the security data (e.g., 240 of FIG. 2) received in response to its query (e.g., 235 of FIG. 2). By analyzing the received security data, the data analysis component 955 may check for compliance with defined central policies, local policies, or the IdP's default settings. Following the analysis, the command & control component 960 within the IdP may issue commands based on the decision. In some embodiments, the commands (e.g., 245 of FIG. 2) may include a denial of the authentication request or an approval to initiate the authentication process. In some embodiments, the data analysis component 955 may determine that the security data is required to be transmitted to the user device for evaluation (e.g., due to the IdP's setting, the capability of the user device, and/or user's preference). Based on the determination, the command & control component 960 may issue commands that instruct the IdP to forward the security data (e.g., 255 of FIG. 2) to the user device (e.g., 205 of FIG. 2).

In some embodiments, such as when the computing device 900 corresponds to a user device (e.g., 205 of FIG. 2 or 304 of FIG. 3) that supports enhanced security evaluation, the request component 950 may be designed to detect available networks. Upon detecting a network, the request component 950 may generate an authentication request (e.g., 225 of FIG. 2), which indicates the user device's intent to connect. The authentication request may include the device's identifier and the user's credentials, and may be transmitted to the ANP (e.g., 210 of FIG. 2) that manages the particular network. In some embodiments, before sending the authentication request, the request component 950 may generate an ANQP query (e.g., 330 of FIG. 3) to request security data associated with the network managed by the ANP (e.g., 310 of FIG. 3). In some embodiments, the data analysis component 955 within the user device may analyze the received security data (e.g., 255 of FIG. 2, or 345 of FIG. 3) to determine whether the network that it intends to connect to is sufficiently secure. Based on the analysis, the command & control component 960 within the user device may generate and transmit a decision to the IdP and/or the ANP. In some embodiments, the decision (e.g., 265 of FIG. 2) may include a confirmation to proceed with the connection. In some embodiments, the decision may include an authentication request (e.g., 350 of FIG. 3) that indicates the device's intent to connect. In some embodiments, the decision (e.g., 355 of FIG. 3) may indicate the intent to abort the connection.

In the illustrated example, the storage 915 includes a variety of data, such as the central policies 970, the local policies 975, the IdP's default settings, and the historical security data 985 (e.g., security metrics, reputation scores). Although depicted as residing in storage 915, the aforementioned data may be stored in any suitable location, such as a remote database managed by the OR federation system.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
receiving, at a first network device, a request to authenticate connection of a user device to a network;
retrieving, by the first network device, security data associated with the network;
determining, by the first network device, that one or more security criteria are satisfied based on analyzing the security data associated with the network; and
transmitting, by the first network device, a response to the user device, wherein the response instructs the user device to establish a connection with the network and does not disclose the security data.

2. The method of claim 1, wherein:
the first network device comprises an identify provider (IdP) that authenticates user devices based on one or more authentication protocols, and
the request is received from an access network provider (ANP) that manages connections between user devices and the network.

3. The method of claim 2, wherein:
the security data associated with the network is retrieved from a second network device, and
the second network device is integrated into a federation-based system that comprises the IdP and the ANP, and periodically synchronizes the security data associated with the network within a database of the federation-based system.

4. The method of claim 2, wherein:
the security data associated with the network is retrieved from a second network device,
the second network device comprises an application programming interface (API) service, and
retrieving, by the first network device, the security data associated with the network comprises transmitting, by the IdP, structured API calls to the second network device, in order to retrieve the security data associated with the network.

5. The method of claim 1, wherein the security data associated with the network comprises at least one of (i) a reputation score of the network, or (ii) a security profile of the network.

6. The method of claim 1, wherein determining, by the first network device, that the one or more security criteria are satisfied comprises determining, by the first network device, that a reputation score associated with the network exceeds a defined threshold.

7. A method, comprising:
receiving, at a first network device, a request to authenticate connection of a user device to a network;
transmitting, by the first network device, a response to the user device, wherein the response comprises security data associated with the network; and
upon receiving a confirmation from the user device to establish a connection with the network, proceeding to verify an identify of the user device.

8. The method of claim 7, wherein the first network device comprises an access network provider (ANP) that manages connections between user devices and the network.

9. The method of claim 8, wherein the security data associated with the network within the response comprises a reputation score that is cryptographically signed by a second network device.

10. The method of claim 9, wherein the user device, upon receiving the reputation score, verifies an integrity of the reputation score using a public key associated with the second network device.

11. The method of claim 9, wherein the user device compares the reputation score with a defined threshold, and upon determining that the reputation score exceeds the defined threshold, transmits the confirmation to the first network device, wherein the confirmation instructs the first network device to establish the connection with the network.

12. The method of claim 7, wherein:
the first network device comprises an identify provider (IdP) that authenticates user devices based on one or more authentication protocols, and
the request is received from an access network provider (ANP) that manages connections between user devices and the network.

13. The method of claim 12, further comprising, prior to transmitting the response to the user device, retrieving, by the first network device, the security data associated with the network from a second network device.

14. The method of claim 13, wherein the second network device is integrated into a federation-based system that comprises the IdP and the ANP, and periodically synchronizes the security data associated with the network within a database of the federation-based system.

15. The method of claim 13, wherein the second network device comprises an application programming interface (API) service, and wherein retrieving, by the first network device, the security data associated with the network from the second network device comprises transmitting, by the IdP, structured API calls to the second network device, in order to retrieve the security data associated with the network.

16. The method of claim 13, wherein the security data associated with the network comprises at least one of (i) a reputation score of the network, or (ii) a security profile of the network.

17. The method of claim 13, wherein:
the user device, upon determining that one or more security criteria are satisfied, transmits the confirmation to the first network device, and
the confirmation instructs the first network device to establish the connection with the network.

18. A system comprising:
one or more memories collectively storing computer-executable instructions; and
one or more processors configured to collectively execute the computer-executable instructions and cause the system to:
receive, at a first network device, a request to authenticate connection of a user device to a network;
retrieve, by the first network device, security data associated with the network;
determine, by the first network device, that one or more security criteria are satisfied based on analyzing the security data associated with the network; and
transmit, by the first network device, a response to the user device, wherein the response instructs the user device to establish a connection with the network and does not disclose the security data.

19. The system of claim 18, wherein:
the first network device comprises an identify provider (IdP) that authenticates user devices based on one or more authentication protocols, and
the request is received from an access network provider (ANP) that manages connections between user devices and the network.

20. The system of claim 19, wherein:
the security data associated with the network is retrieved from a second network device, and
the second network device is integrated into a federation-based system that comprises the IdP and the ANP, and periodically synchronizes the security data associated with the network within a database of the federation-based system.
